(19) United States
(12) Patent Application Publication
(10) Pub. No.: US 2026/0089635 A1
(43) Pub. Date: Mar. 26, 2026

(54) EMBEDDING A WAKEUP SIGNAL IN AN ORTHOGONAL FREQUENCY-DIVISION MULTIPLEXING (OFDM) DATA PACKET

(71) Applicant: Cypress Semiconductor Corporation, San Jose, CA (US)

(72) Inventors: Kiran Uln, Pleasanton, CA (US); Daniel Lee, Salt Lake City, UT (US); Rakesh Taori, Mckinney, TX (US)

(73) Assignee: Cypress Semiconductor Corporation, San Jose, CA (US)

(21) Appl. No.: 18/898,175

(22) Filed: Sep. 26, 2024

(51) Int. Cl. H04W 52/02; H04L 5/00

(52) U.S. Cl. CPC H04W 52/0235; H04L 5/001; H04L 5/0094

(57) ABSTRACT

Systems and methods are described herein for embedding a wakeup signal in an Orthogonal Frequency Division Multiplexed (OFDM) data packet to implement a wakeup radio protocol. An example method may include receiving data to be wirelessly transmitted to a wireless client via an Orthogonal Frequency Division Multiplexed (OFDM) wireless communication protocol. The method may also include identifying one or more wakeup signal parameters associated with the wireless client, wherein the wakeup signal parameters comprise a selected sub-carrier. The method may also include, during transmission of a data packet, over-riding the selected sub-carrier of the data packet with a wakeup signal to cause the wireless client to wake from a power saving mode.

### TECHNICAL FIELD

Aspects of the present disclosure generally relate to wireless technology, and in particular, techniques for generating a wakeup signal to support power savings in wireless communication devices.

### BACKGROUND

Wireless network protocols such as Wi-Fi enables wireless communication between devices such as computers, smartphones, tablets, and Internet of Things (IoT) devices. Many wireless network protocols provide a power-saving mode to optimize power management by allowing devices to sleep for extended periods. Wireless devices can improve power efficiency by negotiating scheduled wake times during which the wireless devices are to wake up and receive or transmit data. Outside of scheduled wake times, the wireless device may enter a reduced power state to conserve power.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for providing power savings through the use of a wakeup radio, in accordance with some embodiments of the present disclosure.

FIG. 2 is a frequency-time representation of an OFDM signal in accordance with some embodiments of the present disclosure.

FIG. 3 is a block diagram of an example RF transmitter configured to transmit wakeup signals in accordance with some embodiments of the present disclosure.

FIG. 4 is a block diagram of an example RF receiver that may be implemented in a wakeup radio in accordance with some embodiments of the present disclosure.

FIG. 5 is a process flow diagram of a method of waking a wireless client from a power saving mode, in accordance with some embodiments of the present disclosure.

FIG. 6 is a process flow diagram of a method of operating a wireless client with a wakeup radio, in accordance with some embodiments of the present disclosure.

FIG. 7 illustrates a diagrammatic representation of a machine in the example form of a computer system within which a set of instructions, for causing the machine to perform any one or more of the methodologies discussed herein for implementing a wakeup radio protocol.

### DETAILED DESCRIPTION

Wireless communication technologies have become pervasive throughout a wide variety of consumer, healthcare, and industrial applications, including smart home devices, industrial Internet of Things (IoT), health-monitoring devices, smart city devices, energy management, agricultural and environmental monitoring, and many others. Power efficiency may be a concern for many of these applications. For example, some wireless devices operate on battery power. Efficient use of power may allow such wireless devices to operate for longer periods of time without charging or replacing the battery.

Many wireless communication protocols implement protocols that enable power savings. For example, the Wi-Fi protocol includes targeted-wait-time (TWT) mechanism that improves power efficiency by negotiating scheduled wake times for the wireless devices to wake up and receive or transmit data. The wireless device is able to stay in a reduced power state in between wakeup intervals. At the scheduled wakeup interval, the wireless device wakes up to determine whether there is any data waiting to be transmitted to the wireless device. If so, the wireless device can begin network communications. If there is no data waiting to be transmitted, the wireless device can reenter the reduced power state. In many use cases, it can be expected that there will be no data to transmit during most wakeup times, in which case, the process of waking up wastes power.

In many use cases, the initiation of wireless communication is event triggered. For example, one type of event may be a user attempting to access a wireless device such as a doorbell camera, in which case, the wireless device should be able to respond in a timely manner. In cases that demand high availability, the wakeup interval will generally be configured to reduce latency, which means that the wakeup interval will be relatively short (e.g., hundreds of milliseconds) even though the probability of occurrence of the triggering event is very small at any time of the day. In some use cases, the wireless device may even be configured to be constantly available, without ever entering a reduced power state. High availability implies higher power consumption resulting in shorter battery lives.

The present disclosure addresses the above-noted and other deficiencies by providing techniques for generating a wakeup signal for waking up a wireless device. In accordance with embodiments disclosed herein, the wakeup radio is a low power device that is included in the wireless device and communicatively coupled to a wireless communication module. The wakeup radio stays on (no reduced power state) and continuously monitors for a signal, referred to herein as a wakeup signal, indicative of a triggering event. Upon receipt of the wakeup signal, the wakeup radio sends a signal to the wireless communication module that forces the communication module to wake from the power saving state. In this way, the wireless device can respond to the triggering event even between wakeup intervals. Accordingly, the wakeup interval can be extended or even eliminated without increasing response latency in high availability applications. Thus, the wireless device is able to conserve power by remaining in the power saving state for longer periods of time.

Additionally, the present disclosure provides techniques for embedding the wakeup signal in an orthogonal frequency-division multiplexing (OFDM) packet. OFDM is a digital modulation scheme used in many communication protocols, including wireless local area networks (LAN) such as Wi-Fi. In OFDM, the digital data to be transmitted is parallelized and transmitted in multiple sub-carrier frequencies, sometimes referred to as tones. Error correction techniques such as forward error correction (e.g., convolutional coding), Reed-Solomon coding, and time/frequency interleaving may be applied to the signal to improve reliability by overcoming errors introduced by affects such as multipath propagation and Doppler effects.

One possible way to embed a wakeup signal in an OFDM packet is to add the wakeup signal in the time domain prior to transmission of the OFDM packet. However, such a wakeup signal may tend to create high levels of unwanted interference with the other signals being transmitted by the host, raising the noise floor for both the host signals and the wakeup signal.

Another possible way to embed a wakeup signal in an OFDM packet is to toggle one or more OFDM packets on and off, a technique known as on-off keying (OOK). However, such as technique would generate intermodulation products that contribute to spectral growth and reduction of signal quality. Additionally, such a technique would demand the use of a wide-band receiver, which would be more susceptible to interference from adjacent channels. On-off keying would also not be well suited for embedding multiple wakeup signals in a data packet. Such a transmission also relies on availability of free air time, which can be tricky in some bands, like 2.4 GHz.

To addresses the above-noted and other deficiencies, the wakeup signal is embedded in a selected OFDM sub-carrier. In accordance with some embodiments, the wakeup signal over-rides the selected sub-carrier, such that the regular packet data being transmitted is replaced with the wakeup signal. The wakeup signal may be modulated using amplitude modulation or phase modulation (e.g., differential phase modulation), for example. Due to the redundancy inherent in the error correction techniques applied to the signal being transmitted, the loss of one or a few sub-carriers can be tolerated without significant reduction in performance.

By embedding the wakeup signal in a single subcarrier, the receiver on the wireless client can operate over a narrow bandwidth, which makes it less susceptible to RF interference and improves reliability. Additionally, multiple wakeup signals targeting multiple wireless clients can be embedded in the same OFDM packet with minimal loss in the signal to noise ratio (SNR) affecting the original OFDM packet. Thus, the present techniques can be incorporated in existing communication protocols (e.g., Wi-Fi) while meeting current compliance standards. The wakeup signal techniques described herein can be incorporated in a wide variety of wireless hosts with inexpensive changes to existing hardware, such as wireless access-points.

As discussed herein, the present disclosure provides an approach that improves the operation of a computer system by implementing a wakeup radio that enables a wireless device to wake from a power saving state without having to periodically wake itself in accordance with a predetermined schedule. In addition, the present disclosure provides an improvement to the technological field of wireless technology by providing a wakeup protocol that results in longer sleep times and reduced battery consumption. By way of example, the following description may refer to the Wi-Fi protocol (i.e., the IEEE 802.11 WLAN protocol). However, embodiments of the present disclosure may be implemented in any suitable wireless communication protocol that uses OFDM, including Wi-Fi, WiMax, Ultra-wideband (UWB), cellular technologies such as 4G, 5G, and others.

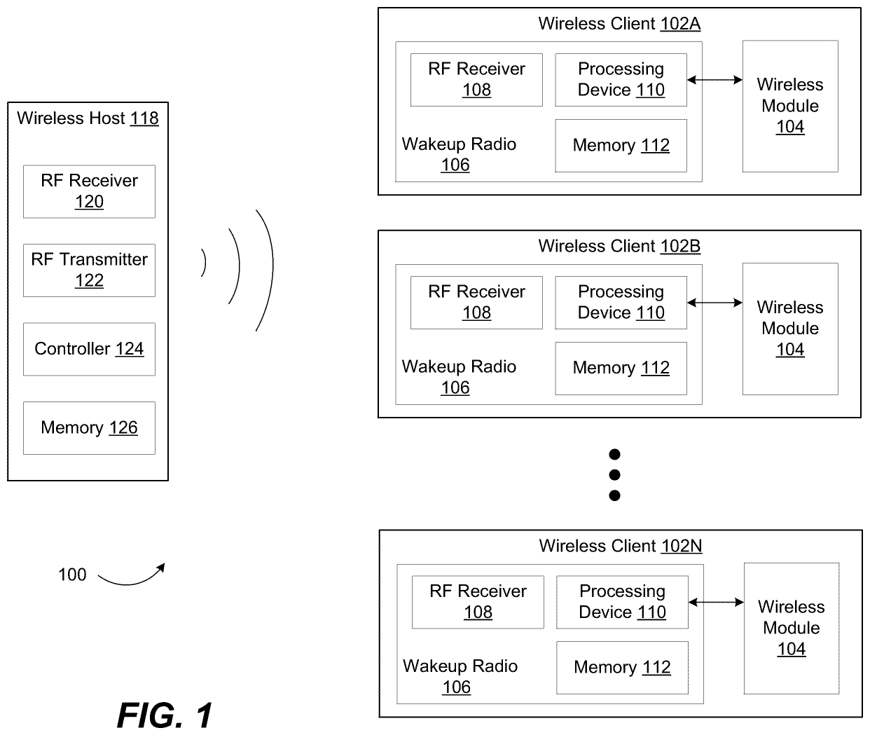

FIG. 1 is a block diagram that illustrates an example system for providing power savings through the use of a wakeup radio, in accordance with some embodiments of the present disclosure. The example system 100 includes a wireless client 102 having wireless networking capabilities. The wireless client 102 may be any suitable type of electronic device and may be an edge device (e.g., network endpoint). For example, the wireless client 102 may be an IoT device (e.g., IoT sensor), a smart home device (e.g., smart thermostat, lock, lighting, etc.), a security camera, a health monitoring device, wearable medical sensors, smart cities device (e.g., smart lighting, parking meter, traffic monitor), energy management device (e.g., smart electricity meter), consumer electronics (e.g., television, wireless speaker, etc.), and others.

In some embodiments, the wireless client 102 may be a non-Access Point station (non-AP STA), which refers to a device that is equipped with a wireless network interface controller and uses a Wi-Fi protocol to connect to other devices or networks, but does not have access point capability. An Access Point (AP) is a specialized type of station that serves as a central transmitter and receiver of wireless radio signals. A station that has access point capability is typically referred to as an AP, a wireless access point (WAP), or a simply a station (STA). A station that does not have access point capability is typically referred to as non-AP station (non-AP STA). Non-AP stations are typically end devices (e.g., IoT devices) that communicate with a station (e.g., wireless access point) to gain network connectivity.

The wireless client 102 includes a wireless module 104 that enables the wireless client to access one or more wireless networks. The wireless module 104 may use any suitable wireless protocol, including Wi-Fi, Bluetooth, and others. The wireless module 104 may also be configured to operate in accordance with a combination of different protocols. For example, the wireless module may be Wi-Fi and Bluetooth capable. Additionally, it will be appreciated that although a single wireless module is shown, the wireless client 102 may include two or more wireless modules 104, each for accessing a different type of wireless network.

The system also includes a wireless host 118 configured to communicate with the wireless client 102 via the wireless module 104. In some embodiments, the wireless host 118 may be a wireless access point (AP) that serves as a central transmitter and receiver of wireless radio signals. For example, the wireless host 118 may be a home wireless router connected to the Internet via an Internet service provider. In some embodiments, the wireless host 118 may be a wireless repeater that extends the range of the wireless network. The wireless host 118 may also be communicatively coupled to a network (not shown), which may be a public network (e.g., the Internet), a private network (e.g., a local area network (LAN), wide area network (WAN)), or a combination thereof. For example, the network may be an enterprise network of a facility such as a hospital, warehouse, manufacturer, or other business enterprise. The network may also be a public network, such as the Internet.

In some embodiments, the wireless host 118 may be a personal computing device capable of communicating with the wireless clients 102A-N through direct wireless communication (e.g., Wi-Fi, Bluetooth, and others). For example, the wireless host 118 may be any suitable type of end user electronic equipment, such as a smart phone, personal computer (e.g., desktop, laptop, etc.), tablet computer, and the like. If the wireless host 118 uses the Wi-Fi protocol, it may be referred to as a wireless access point (WAP), a station (STA), or a non-AP station. However, it will be appreciated that the wireless host 118 may use any suitable communication protocol.

The wireless host 118 may include an RF receiver 120, RF transmitter 122, controller 124, and memory 126. The RF receiver 120 and RF transmitter 122 may be components of an RF transceiver. The controller 124 may be any suitable type of processing device and controls operations of the wireless host 118, including the transmission of wakeup signals. The memory 126 may be any suitable type of memory and may be used to store software instructions and configuration data for the wireless host 118. For example, the memory 126 may be used to store wakeup signal parameters in use by each of the wireless clients 102A-N.

The wireless client 102 may be configured to enter various power saving modes, whereby components of the wireless client 102 are fully or partially powered down. For example, the wireless client 102 may enter a power saving mode that powers down the wireless module 104 or portions thereof such as the wireless module's transceiver. The wireless client 102 may be configured to implement a wakeup interval such that the wireless module 104 will periodically exit the power saving mode to determine whether there is any traffic waiting to be transmitted to the wireless client 102. With respect to Wi-Fi embodiments, the power saving mode may be a Wireless Network Management (WNM) sleep mode or a target wait time (TWT) sleep mode. WNM sleep mode is an extended power-saving mode for non-AP stations that causes the station to skip a specified number of Delivery Traffic Indication Message (DTIM) Beacon frames in accordance with a listen interval. The TWT sleep mode is a power save mode wherein the station specifies a time interval for waking to determine if network traffic is available for the station. Other power save modes are also possible.

The wireless client 102 also includes a wakeup radio 106, which is configured to cause the wireless client 102 (e.g., wireless module 104) to transition from the power saving mode to an active mode. In the active mode, the wireless module 104 may be turned on operable such that the wireless client 102 is able communicate with the wireless host 118 to send and receive data wirelessly. The wakeup radio 106 is configured to be continuously active and listening for a wakeup signal to be transmitted wirelessly by the wireless host 118.

The wakeup radio 106 may include a Radio Frequency (RF) receiver 108, a processing device 110, and a memory 112. The RF receiver 108 is configured to receive radio-frequency signals and may include circuitry used to receive and decode radio-frequency signals. The RF receiver 108 may be configured to operate at any suitable frequency or range of frequencies, which may be the same as or different from the frequency range of the wireless module 104. Additionally, the RF receiver 108 and the wireless module 104 may be coupled to the same antenna or antenna array. However, in some embodiments, the RF receiver 108 may also be coupled to a separate antenna included as a component of the wakeup radio 106 and dedicated for the use of the wakeup radio 106.

The processing device 110 may be an application specific integrated circuit (ASIC), a field programmable gate array (FPGA), a microcontroller, etc. The memory 112 may be one or more of a random-access memory (RAM), a solid-state memory (e.g., flash memory), Read-only memory (ROM), a cache, etc. In some embodiments, the memory 112 may be an integrated component of the processing device 110. Additionally, the memory 112 may be a read-only memory, a writable memory, or a combination thereof.

In some embodiments, the wakeup radio 106 may be battery powered and/or powered by an ambient energy source such as visible light (photovoltaic), thermal energy (e.g., thermoelectric), kinetic energy (e.g., piezoelectric), radio waves, and the like. The wakeup radio 106 may also be powered by an external energy source such as a battery of the wireless client 102 or AC power provided to the wireless client 102.

The RF receiver 108 can receive wireless signals and decode the signals to generate digital data, which is communicated to the processing device 110. The processing device 110 may then determine whether the received digital data matches the wakeup signal. Upon detection of the wakeup signal, the wakeup radio 106 signals the wireless module to enter the active mode. If the wireless client 102 is in a power saving mode at the time, the wireless client 102 exits the power saving mode and enters the active mode, in which case the wireless module 104 is powered on. Once powered on, the wireless module 104 can listen for wireless communications directed to the wireless client 102. For example, the wireless module 104 may receive a Beacon from the wireless host 118 indicating that data packets are waiting to be transmitted to the wireless client 102. Wireless communications may then proceed as normal in accordance with the relevant wireless communication protocol.

In some embodiments, the wakeup radio 106 of each wireless client 102A-N is associated with a unique wakeup signal so that individual wireless clients 102A-N can be woken up independently. The wakeup signal parameters applicable to a particular wireless client 102 (e.g., the frequency range of the wakeup signal, the specific bit pattern used to wake a specific wireless client 102) may be negotiated between the wireless host 118 and each wireless client 102. For example, the wireless client 102 may specify a particular sub-carrier index and/or bit pattern, and the wireless host 118 can confirm that these wakeup signal parameters have been received and are not in use by another wireless client 102. In another example, the wireless host 118 may select the parameters to be assigned to each of the wireless clients 102A-N, and the wireless clients 102A-N acknowledge receipt of the wakeup signal parameters.

The wakeup radio 106 can be configured to constantly monitor all of the wireless signals that it detects, regardless of what type of packet or frame the wakeup signal is associated with. The wakeup signal may include a specific sequence of symbols, such as a specific pattern of ones and zeros, which may be stored in memory 112. This pattern may be referred to as the wakeup bit pattern. In some embodiments, the wakeup radio 106 is programmed with static wakeup signal parameters, meaning that the wakeup signal parameters for the wireless client 102 do not change. In such embodiments, the wakeup radio may be pre-tuned to a specific frequency range and the wakeup bit pattern may be programmed into the wakeup radio 106 using a small amount of read-only memory, such as electrically erasable programmable read-only memory (EEPROM). In other embodiments, the wakeup signal parameters can be re-programmed during deployment. For example, the wireless host 118 and the wireless clients 102A-N can coordinate to ensure that each wireless client 102 is associated with a unique sub-carrier and/or wakeup bit pattern. This enables specific wireless clients 102 to be woken up individually or in clusters. In embodiments where the wakeup signal parameters are negotiated between the wireless client 102 and the wireless host 118, the wakeup signal negotiation may be carried out by the wireless module 104 and once the wakeup signal parameters are established, the wireless module 104 may send the wakeup signal parameters to the wakeup radio 106 to be stored to the memory 112.

The wireless client 102 may also periodically obtain new wakeup signal parameters. For example, the wakeup radio 106 may implement an entropy-based wakeup signal change. Changing the wakeup signal over time can help to improve security by preventing an unauthorized user from learning the wakeup signal.

When the wakeup radio 106 detects the wakeup signal in use by the wireless client 102, the processing device 110 may send an activation signal to the wireless module 104. In some embodiments, the activation signal may be sent to the wireless module 104 using any suitable chip-to-chip communication protocol, such as SPI (Serial Peripheral Interface), I2C (Inter-Integrated Circuit), and others. The activation signal may be sent to the wireless module 104 via a single signal line.

If the wireless module 104 is in a power saving mode subject to a wakeup interval (e.g., TWT interval), the activation signal will cause the wireless module 104 to enter the active mode early, e.g., prior to the next scheduled wake time. In this way, the wireless client 102 is able to implement longer wakeup intervals without an increase in latency between a triggering event and the wireless module 104 becoming active. Additionally, the techniques described herein also enable the wireless module 104 to enter an indefinite power saving mode, i.e., a power saving mode without a scheduled wake time or wakeup interval. Accordingly, the use of the wakeup radio 106 allows the wireless module 104 to stay in the power saving mode for longer periods of time, thereby conserving power and extending battery life.

The wireless host 118 may include code (e.g., software, firmware) that is executable to issue wakeup signals targeted to wake up specific wireless devices. The code may be pre-installed by the manufacturer or by an IT management team, for example. In some embodiments, the software code may be downloaded to the wireless host 118 as part of a procedure for configuring the wireless client 102. Such software may be downloaded from a cloud service that provides services associated with the wireless client 102. For example, upon purchasing a new device such a smart home device, the user may download an app to configure the smart home device and associate the device with a user account registered with the cloud service. As part of the configuration process, the user may provide information (e.g., IP address) that enables the cloud service to install an application on the wireless host 118. In some embodiments, the cloud service also provides the wakeup signal parameters (e.g., sub-carrier index, wakeup bit pattern, etc.) associated with the wireless client 102 to the wireless host 118.

As described further below, the wireless host 118 may embed the wakeup signal in an OFDM sub-carrier during transmission of regular packet data intended for a different wireless client. The wakeup signal over-rides the selected sub-carrier, such that the regular packet data being transmitted is replaced with the wakeup signal. As described further below, the wakeup signal may be modulated using amplitude modulation or phase modulation (e.g., differential phase modulation), for example.

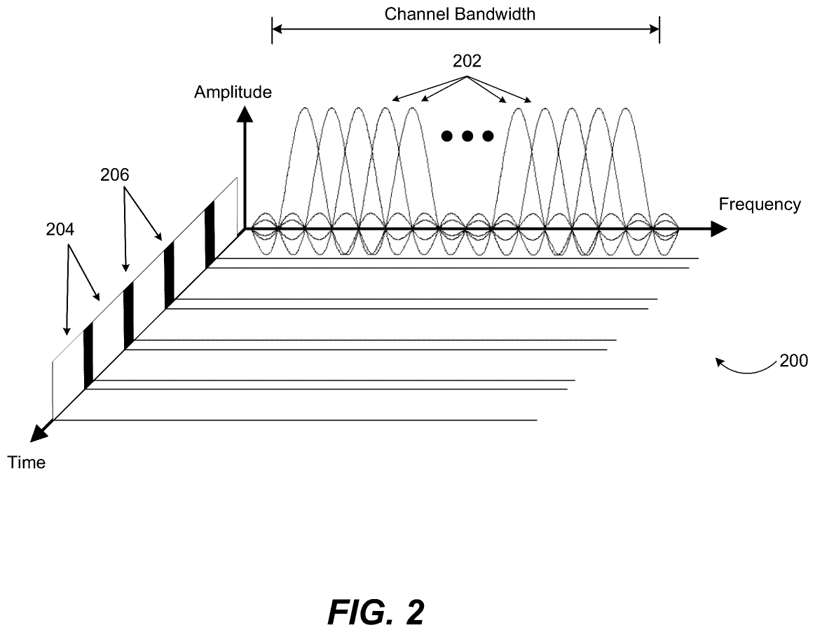

FIG. 2 is a frequency-time representation of an OFDM signal in accordance with some embodiments of the present disclosure. Orthogonal frequency-division multiplexing (OFDM) is a type of digital transmission used to encode digital data on multiple orthogonal carrier frequencies, referred to herein as sub-carriers 202. As shown in FIG. 2, the horizontal axis represents frequency, the vertical axis represents amplitude or a metric of the information being transmitted, and the axis coming out of the page represents time.

The sub-carriers 202 are closely spaced orthogonal signals with overlapping frequency spectra. The spacing between sub-carriers 202 is orthogonal, which eliminates or reduces crosstalk and interference between the sub-carriers despite the overlap. Each sub-carrier 202 is modulated separately to encode bits from the incoming bit stream into one of several symbols 204, where each symbol represents one or more bits of the bit stream depending on the modulation scheme. The use of several sub-carriers 202 enables multiple bits to be transmitted in parallel. Each of the sub-carriers 202 may be modulated using one of various Quadrature amplitude modulation (QAM) techniques, such as BPSK (Binary Phase Shift Keying), QPSK (Quadrature Phase Shift Keying), 16 QAM (16-state QAM), 64 QAM (64-state QAM), and others.

The time axis shows the transmission of symbols 204 over time. It will be appreciated that although one series of symbols 204 is shown, each sub-carrier 202 will be modulated separately such that each sub-carrier 202 transmits its own series of symbols. In some embodiments, guard intervals 206 may be interposed at symbol transitions to provide time separation between the symbols 204.

The channel bandwidth and number of sub-carriers may be any suitable combination of values depending on the specifications of the communication protocol used to implement the disclosed techniques. For example, some Wi-Fi systems can use channels with bandwidths of 20, 40, 80, and 160 MHz. Each 20 MHz channel may be divided into 64 sub-carriers each with a sub-carrier bandwidth of 312.5 kHz or 256 sub-carriers each with a sub-carrier bandwidth of 78.125 kHz. Additionally, it will be appreciated that many communication systems may operate over a plurality of channels. An 80 MHz Wi-Fi system may have as many as 1024 sub-carriers or more.

A wakeup signal may be imbedded within an OFDM data packet by over-riding one of the sub-carriers to transmit the wakeup signal in place of the original packet data. Each wakeup radio may be configured to monitor the frequency corresponding with a particular sub-carrier to listen for the wakeup signal. The wakeup signal may be transmitted over a plurality of symbol transitions. For example, the wakeup signal may be transmitted on the selected sub-carrier in a repeating pattern over the full duration of the packet. In some embodiments, the transmission of the wakeup signal can start after the Physical Layer Convergence Protocol (PLCP) preamble, which is used for synchronization carries information about the modulation and coding schemes being used. After the preamble, the wakeup signal can be transmitted on the selected sub-carrier in a repeating pattern for the remainder of the data packet.

Any suitable modulation scheme can be used to transmit the wakeup signal. For example, the wakeup signal may be a phase modulated signal (e.g., differential phase modulated) or an amplitude modulated signal. In some embodiments, the wakeup signal may be transmitted using a higher order QAM modulation (e.g., 4-QAM, 16-QAM, etc.) It will be appreciated that the modulation scheme used to transmit the wakeup signal can be different from the modulation scheme used to encode the packet data. In some embodiments, scrambling may be used to manipulate the power spectrum of the wakeup signal to reduce the possibility for interference with other sub-carriers.

Several of the sub-carriers 202 may be over-ridden with a wakeup signal without significantly degrading the signal quality. For example, over-riding one sub-carrier may cause approximately ¼ dB reduction in SNR at the receiver with regard to the original packet data. Accordingly, multiple wakeup signals can be transmitted at the same time within a single data packet and/or within a same wireless channel. Each sub-carrier may be used to target an individual wireless radio or cluster of wireless radios that have been configured to monitor the range of frequencies associated with that specific sub-carrier. In some embodiments, approximately 10 to 20 percent of the sub-carriers may be used to transmit wakeup signals at any given time.

As described above in relation to FIG. 1, the wireless host 118 may negotiate the wakeup signal parameters with each of the wireless clients 102A-N. Configurable parameters of the wakeup signal may include the sub-carrier index or frequency range, modulation scheme, and/or the wakeup bit pattern, for example. The negotiation process may also indicate a number of cycles over which the wakeup signal parameters will be valid. In such embodiments, the activation signal parameters can be renegotiated once they are no longer valid.

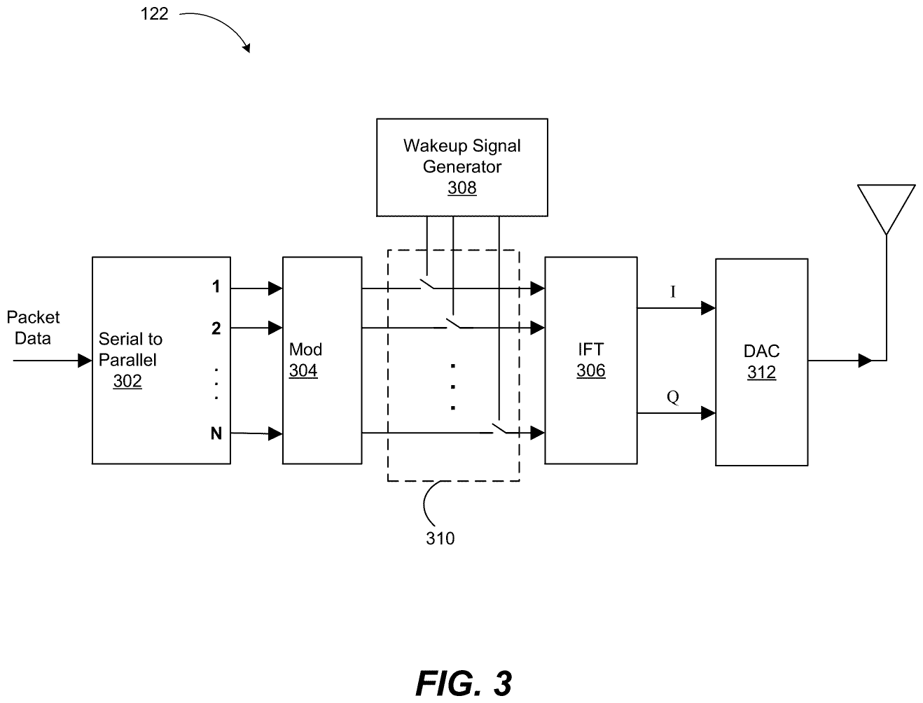

FIG. 3 is a block diagram of an example RF transmitter 122 configured to transmit wakeup signals in accordance with some embodiments of the present disclosure. Components of the RF transmitter 122 may be implemented in any suitable type of processing logic, including include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. The transmitter 122 may be included in the wireless host 118 shown in FIG. 1. It will be appreciated that an actual transmitter in accordance with embodiments may include more or fewer components compared to what is shown in FIG. 3.

As shown in FIG. 3, the transmitter 122 includes a chain of components that perform various functions to transform a stream of packet data to an OFDM signal suitable for wireless transmission. This chain of components, referred to herein as the transmission chain, includes a serial-to-parallel conversion block 302, a modulator 304, an Inverse Fourier Transform (IFT) module 306, and a Digital-to-Analog Converter (DAC) 312.

The serial-to-parallel conversion block 302 receives the packet data in the form of a serial bit stream. The serial-to-parallel conversion block 302 parallelizes the serial data and also groups the bits into symbol groupings. The number of bits in each symbol grouping will depend on the modulation scheme. For example, 16-QAM modulation can encode four bits of data per symbol. The output of the serial-to-parallel conversion block 302 will be a number (N) of parallel data streams carried on N parallel data lines, each data line corresponding to one of the N sub-carriers 202 shown in FIG. 2.

The output of the serial-to-parallel conversion block 302 is sent to the modulator 304, which maps each bit grouping to its corresponding symbol in accordance with the applied modulation scheme. Each symbol output by the modulator 304 may be a complex number used to represent a specific signal amplitude and phase.

The transmitter 122 may also include a wakeup signal generator 308 and a switch array 310. The switch array 310 enables the wakeup signal generator 308 to insert the wakeup signal into the transmission chain on a selected data line. For example, each switch in the switch array 310 may be a 2-to-1 multiplexer that enables the controller 124 (FIG. 1) to select between the normal packet data or the wakeup signal for each data line. If the wakeup signal is inserted onto one or more data lines, the portion of the regular packet data carried on those particular data lines is replaced by the wakeup signal.

In the example transmitter of FIG. 3, the wakeup signal is inserted into the transmission chain after the modulator 304 and before the IFT module 306 (i.e., within the frequency domain). Specifically, the switch array 310 is disposed between the modulator 304 and the IFT module 306 and enables the modulator 304 or the wakeup signal generator 308 to provide the input to the IFT module 306 on selected input lines.

The switch array 310 may be controlled by the controller 124 shown in FIG. 1. Each switch in the switch array 310 may be controlled separately to couple the corresponding input line of the IFT module 306 to the output of the modulator 304 or to the output of the wakeup signal generator 308 depending on whether a wakeup signal is to be transmitted. If no wakeup signal is being transmitted, each switch in the switch array 310 is connected to the output of the modulator 304 and each of the N symbols output by the modulator 304 is received at the IFT module 306.

If a wakeup signal is to be transmitted, the switch array 310 is controlled so that the line associated with the sub-carrier of interest is decoupled from the output of the modulator 304 and coupled to the output of the wakeup signal generator 308. The sub-carrier of interest may be selected depending on which wireless client is to be woken. For example, upon receiving an indication that a particular wireless client is to be woken, the controller 124 may identify the wakeup signal parameters applicable for the wireless client (e.g., using a lookup table stored to the memory 126). The wakeup signal parameters may include information such as the sub-carrier associated with the wireless client, the particular wakeup bit pattern associated with wireless client (e.g., the series of ones and zeros), the modulation scheme to be used to generate the wakeup signal, and others. The wakeup signal generator 308 may then output a series of symbols on the selected line to generate the identified bit pattern on the identified sub-carrier using the identified modulation scheme.

The IFT module 306 converts the input symbols that it receives from the frequency domain to the time domain. The IFT module 306 may be configured to apply any suitable Fourier transform algorithm, including Inverse Fast Fourier Transform (IFFT) and others. The IFT module 306 also associates a specific frequency range with each of the N inputs so that the conversion of each symbol to its equivalent time domain representation is in the correct frequency band of the designated sub-carrier.

The output of the IFT module 306 is the In-phase (I) signal component and Quadrature (Q) signal component that represents the combined set of symbols to be transmitted at each sub-carrier. The I and Q signal components are converted by the Digital-to-Analog Converter (DAC) 312 to a combined analog IQ signal suitable for wireless transmission. The DAC 312 may include one or more digital multipliers (e.g., RF mixers), adders (e.g., RF combiners), filters, amplifiers (e.g., power amplifiers), etc. to perform the conversion. For example, the I and Q components may be multiplied to create separate sine and cosine representations, which are then added together to form a combined IQ signal. Additionally, a multiplier may be used to up-convert the combined IQ signal to the desired center frequency for the channel.

It should be noted that the modulation scheme applied to the normal packet data by the modulator 304 can be different from the modulation scheme used by the wakeup signal generator 308 to generate the wakeup signal. In some embodiments, the modulator 304 may be configured to use a higher order QAM modulation scheme compared to the wakeup signal generator 308. For example, if the modulator 304 is using 16-QAM, the wakeup signal generator may use 4-QAM. In 4-QAM, four symbols are used to represent two bits per symbol. In some embodiments, the wakeup signal generator 308 uses a form of phase modulation sometimes referred to as Phase-Shift Keying (PSK), which includes coherent or differential PSK. In coherent phase-shift keying (CPSK), the phase may be determined by comparing the measured phase to a reference signal. In differential phase-shift keying (DPSK), the phase may be determined by comparing the measured phase of one symbol to the phase of the previous symbol. The wakeup signal generator 308 may also be configured to use a form of amplitude modulation referred to as Amplitude-shift keying (ASK). In ASK and PSK, each symbol represents a single bit of information (e.g., zero or one). Thus, ASK and PSK may both be referred to a 2-QAM modulation schemes. Additionally, the particular modulation scheme used by the wakeup signal generator 308 may or may not be programmable. Thus, although embodiments of the present techniques describe the modulation scheme as being negotiated between the wireless host 118 and the wireless clients 102A-N, the modulation scheme used to generate the wakeup signals may be fixed in some embodiments.

At the receiver (e.g., the wireless module 104), the sub-carrier used to transmit the wakeup signal will appear corrupted. However, the error correction techniques implemented by the communication protocol will ensure that the packet data being transmitted by the wireless host 118 can be fully recovered by the wireless module 104. At the same time, the RF receiver 108 of the wakeup radio 106 will be tuned to a narrow range of frequencies that correspond with sub-carrier that the wakeup radio 106 configured to listen to. Therefore, the presence of RF signals outside that narrow frequency range will have little or no effect on the ability of the RF receiver 108 of the wakeup radio 106 to successfully detect wakeup signals. In some embodiments, multiple sub-carriers may be used to transmit multiple wakeup signals targeting different wireless clients 102 within the same data packet transmission. For example, twenty or more sub-carriers within a same data packet may be used to generate separate wakeup signals without significant reduction in signal quality.

It will be appreciated that FIG. 3 shows one example technique for embedding a wakeup signal in a wireless data packet. For example, in some embodiments, the wakeup signal could also be inserted at the input of the modulator 304, in which case, the wakeup signal would override one or more of the bits output by the serial to parallel conversion block 302. In such embodiments, the wakeup signal would be encoded using the same modulation scheme as the remainder of the packet data. Other techniques for inserting a wakeup signal into the wireless data packet are also possible.

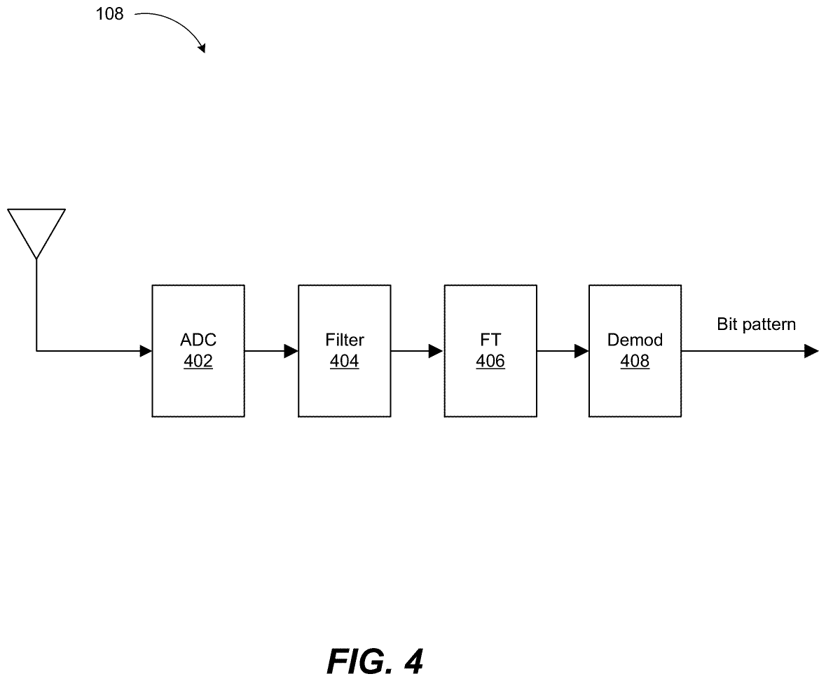

FIG. 4 is a block diagram of an example RF receiver 108 that may be implemented in a wakeup radio in accordance with some embodiments of the present disclosure. Components of the RF receiver 108 may be implemented in any suitable type of processing logic, including include hardware, software, firmware, or a combination thereof. The RF receiver 108 may be included in the wakeup radio 106 of a wireless client 102A-N as shown in FIG. 1. It will be appreciated that an actual RF receiver in accordance with embodiments may include more or fewer components compared to what is shown in FIG. 4.

As shown in FIG. 4, the RF receiver 108 may include an Analog-to-Digital Converter (ADC) 402, filter 404, Fourier Transform (FT) module 406, and a demodulator 408. The ADC 402 converts the received RF signal from analog to a digital representation. The filter 404 may be a digital bandpass filter that processes the digital data received from the ADC 402 to attenuate signal components at frequencies outside the frequency range of interest. The frequency range of interest is the frequency of the corresponding sub-carrier of interest that the RF receiver 108 has been tuned to listen to.

As mentioned above, the sub-carrier of interest may be an adjustable parameter that can be negotiated between the wireless host 118 and the wireless client 102. To facilitate this variability, the pass band of the filter 404 may be programmable to move the frequency range of interest to coincide with the related sub-carrier that the wireless client is configured to listen to. However, in some embodiments, the pass band of the filter 404 may be fixed.

The output of the filter 404 is input to the FT module 406, which converts the data from the time domain to the frequency domain. The FT module 406 may be configured to apply any suitable Fourier transform algorithm, including the Fast Fourier Transform (FFT) and others. The output of the FT module 406 represents the series of symbols that have been transmitted over the sub-carrier of interest.

The output of the FT module 406 is processed by the demodulator 408 to extract a series of bits, referred to herein as the bit pattern. The demodulator 408 may be configured to use any suitable demodulation scheme. In embodiments that use phase modulation (e.g., phase shift keying) or amplitude modulation (e.g., amplitude shift keying) the output of the demodulator 408 during each symbol period will represent a single bit (e.g., one or zero). In embodiments that use higher order QAM modulation, the output of the demodulator 408 during each symbol period will represent a group of bits (e.g., two bits for 4-QAM, 3 bits for 8 QAM, etc.). In such embodiments, the output of the demodulator 408 may be sent to a serializer (not shown), which outputs the bits serially to produce the bit pattern.

The bit pattern may be sent to the processing device 110 (FIG. 1) do determine whether the extracted bit pattern matches the wakeup bit pattern programmed into the wakeup radio. In embodiments, the processing device 110 receives a continuous stream of bits, which may be processed using a rolling window of a size equal to the number of bits in the wakeup pattern.

It will be appreciated that FIG. 4 shows a simplified example of an RF receiver configured to listen for a wakeup signal and that various alterations may be made without deviating from the scope of the present disclosure. For example, the RF receiver 108 may include an RF amplifier, often called the low-noise amplifier (LNA), to amplify the received signals. Additionally, the RF signal may be filtered in the analog domain to, either in place of or in addition to the filter 404. Other variations are also possible in accordance with embodiments.

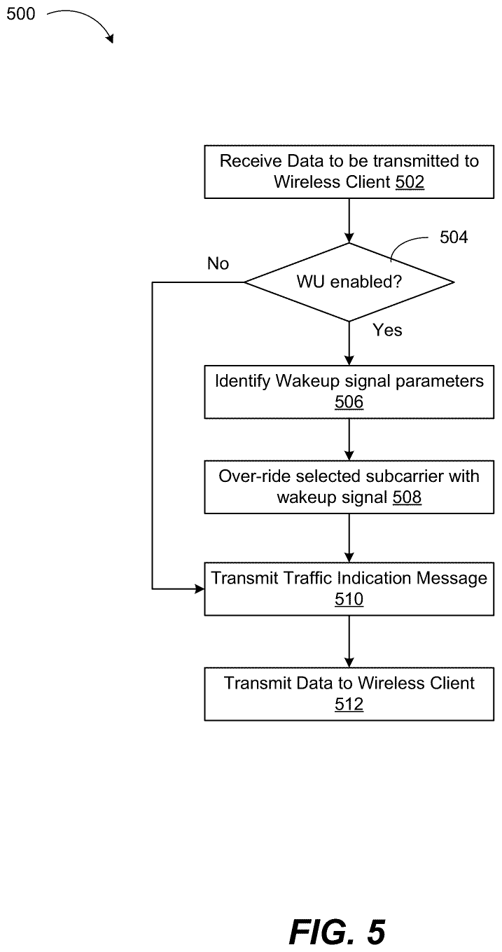

FIG. 5 is a process flow diagram of a method of waking a wireless client from a power saving mode, in accordance with some embodiments of the present disclosure. Method 500 may be performed by processing logic that may include hardware, software, firmware, or a combination thereof. In some embodiments, at least a portion of method 500 may be performed by the wireless host 118 shown in FIG. 1. The method 500 may begin at block 502.

At block 502, data to be transmitted to a wireless client is received. In the case of a Wireless AP, the data may be received from another device connected to the wireless network, or through an Internet service provider, for example. In the case of a personal device such as a smart phone, the data may be a user command to control a smart home device, such as a door lock, thermostat, lights, etc. For example, the data may be an instruction to turn a one or more lights on or off, lock or unlock a door, etc. The data may identify a destination for the data such as an IP address of the wireless client.

At block 504, a determination is made regarding whether the wireless client identified as the destination for the data is enabled for wakeup signal detection. For example, the wireless host may use a lookup table that associates each wireless device with relevant wakeup signal parameters for the wireless client. In some embodiments, not every wireless client will be equipped with a wakeup radio and will therefore not be enabled for wakeup signal detection. If the wireless client identified as the destination is not enabled for wakeup signal detection, the process flow may advance to block 510 and communication with the wireless client resumes in accordance with the wireless communication protocol in use.

If the wireless client is enabled for wakeup signal detection, the process flow advances to block 506 and the applicable wakeup signal parameters identified. For example, the wakeup signal parameters may be retrieved from the lookup table. The wakeup signal parameters may include a wakeup bit pattern, for example, a sequence of ones and zeros to be encoded as an RF signal and embedded in a wireless OFDM packet. The wakeup signal parameters may also specify an OFDM sub-carrier to be used to transmit the wakeup signal. The wakeup signal parameters may also specify a particular modulation scheme to be used to encode the wakeup signal.

At block 508, the wakeup signal is transmitted by over-riding the selected sub-carrier with the wakeup signal in accordance with the wakeup signal parameters identified at block 506. In some embodiments, the wakeup signal may be embedded in an OFDM data packet intended for another wireless client in the network. In other words, even though the wakeup signal is intended to wake the wireless client identified as the destination for the data received at block 502, the wakeup signal may be embedded in a data packet addressed to a different wireless client. Thus, the wakeup signal may be embedded in a next data packet to be transmitted regardless of the destination for the data packet carrying the wakeup signal. In some embodiments, several wakeup signals targeted to different wireless clients may be transmitted within a same data packet. If multiple wakeup signals are transmitted, each wakeup signal will occupy a different sub-carrier of the OFDM packet. In some embodiments, sequence of bits that make up the wakeup bit pattern may be replayed several times over the full length of the data packet.

At block 510, the communication with the wireless client resumes in accordance with the wireless communication protocol in use. In some embodiments, may transmit a traffic indication message (e.g., a Wi-Fi DTIM), which notifies any wireless clients listening that data is waiting to be transmitted.

At block 512, the data received at block 502 is transmitted to the wireless client. By the time the data is transmitted, the wireless client will have had time to transition from the power saving mode to the active mode.

The method 500 illustrates example functions used by various embodiments. Although specific function blocks (“blocks”) are disclosed in method 500, such blocks are examples. That is, embodiments are well-suited to performing various other blocks or variations of the blocks recited in method 500. It is appreciated that the blocks in method 500 may be performed in an order different than presented, and that not all of the blocks in method 500 may be performed.

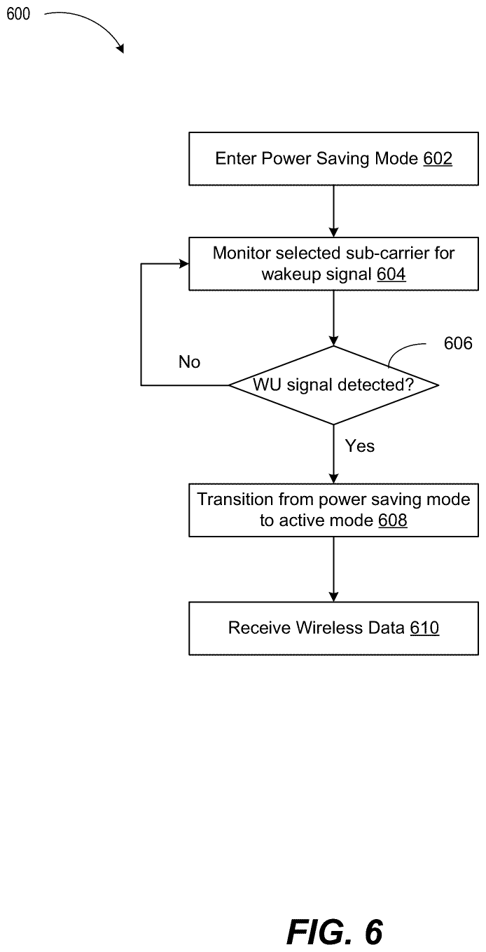

FIG. 6 is a process flow diagram of a method of operating a wireless client with a wakeup radio, in accordance with some embodiments of the present disclosure. Method 600 may be performed by processing logic that may include hardware, software, firmware, or a combination thereof. In some embodiments, at least a portion of method 600 may be performed by the wireless clients 102A-N shown in FIG. 1. The method 600 may begin at block 602.

At block 602, the wireless client enters a power saving mode. The power saving mode may be any type of power saving mode wherein the wireless client or selected components thereof (e.g., wireless module, transceiver, etc.) are powered down and/or entered into a sleep state to conserve power. With respect to Wi-Fi embodiments, the power saving mode may be a WNM sleep mode or a target wait time TWT sleep mode. Other power saving modes are also possible in accordance with embodiments.

At block 604, the wireless client begins monitoring the selected sub-carrier for the wakeup signal applicable to wireless client. The monitoring may be performed by the wakeup radio 106 shown in FIG. 1. Monitoring for the wakeup signal may involve monitoring a range of RF frequencies that correspond with the selected sub-carrier to detect a pattern of bits that matches the wakeup bit pattern programmed into the wireless client. The detection of the waveform pattern is agnostic to the particular package used to carry the wakeup signal. For example, the wakeup signal may be embedded in any OFDM (e.g., Wi-Fi) data packet without regard to the destination of the data packet or other information contained in the data packet.

The monitoring may be performed in accordance with wakeup signal parameters programmed into the wakeup signal, some or all of which may be negotiated in advance by a wireless host (e.g., wireless host 118 of FIG. 1). The wakeup signal parameters may include the wakeup bit pattern, the sub-carrier of interest or frequency range of interest, the demodulation scheme used to decode the wakeup signal, or some combination thereof.

If, at block 606, the wakeup signal is not detected, the process flow returns to the block 604 and the wireless client continues monitoring. If the wakeup signal is detected, the process flow advances to block 608.

At block 608, the wireless client transitions from the power saving mode to the active mode. To transition wireless client to active mode, the wakeup radio may send an activation signal to the wireless client's wireless module (e.g., Wi-Fi module). The activation signal informs the wireless module that data is going to be transmitted in accordance with the wireless module's communication protocol and causes the wireless module to exit from the power saving mode. In some embodiments, the wireless client may also receive a traffic indication message (e.g., a Wi-Fi DTIM).

At block 610, the wireless data is received in accordance with the wireless communication protocol in use (e.g., Wi-Fi data packets that identify the wireless client as the destination for the data). Once the data is received, and if there is no more data to be transmitted to or from the wireless client, the wireless client may transition back to the power saving mode at block 602.

The method 600 illustrates example functions used by various embodiments. Although specific function blocks (“blocks”) are disclosed in method 600, such blocks are examples. That is, embodiments are well-suited to performing various other blocks or variations of the blocks recited in method 600. It is appreciated that the blocks in method 600 may be performed in an order different than presented, and that not all of the blocks in method 600 may be performed.

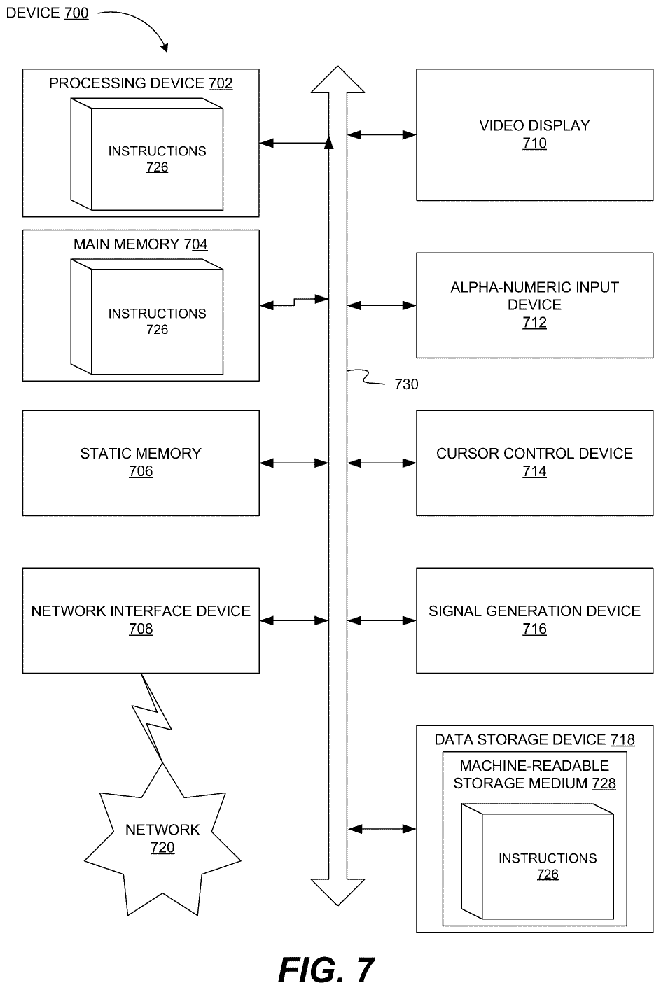

FIG. 7 illustrates a diagrammatic representation of a machine in the example form of a computer system 700 within which a set of instructions, for causing the machine to perform one or more of the methodologies discussed herein for implementing a wakeup radio protocol.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 700 may be representative of a server.

The exemplary computer system 700 includes a processing device 702, a main memory 704 (e.g., read-only memory (ROM), flash memory, dynamic random access memory (DRAM), a static memory 709 (e.g., flash memory, static random access memory (SRAM), etc.), and a data storage device 718 which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing system 700 may further include a network interface device 708 which may communicate with a network 720. The computing system 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 719 (e.g., a speaker). In some embodiments, video display unit 710, alphanumeric input device 712, and cursor control device 714 may be combined into a single component or device (e.g., an LCD touch screen).

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like.

The data storage device 718 may include a machine-readable storage medium 728, on which is stored one or more sets of instructions 726 (e.g., software) embodying any one or more of the methodologies of functions described herein. The instructions 726 may also reside, completely or at least partially, within the main memory 704 or within the processing device 702 during execution thereof by the computer system 700; the main memory 704 and the processing device 702 also constituting machine-readable storage media. The instructions 726 may further be transmitted or received over a network 720 via the network interface device 708. The instructions 726 may be configured for performing any of the techniques described herein, such as embedding a wakeup signal in an OFDM packet, identifying a wakeup signal, and/or transitioning from a power saving mode to an active mode in response to a wakeup signal.

The machine-readable storage medium 728 may also be used to store the instructions 726 for performing the techniques described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “determining,” “identifying,” “embedding,” “broadcasting,” “transmitting,” “receiving,” “sending,” “negotiating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
receiving data to be wirelessly transmitted to a wireless client via an Orthogonal Frequency Division Multiplexed (OFDM) wireless communication protocol;
identifying one or more wakeup signal parameters associated with the wireless client, wherein the one or more wakeup signal parameters comprise a selected sub-carrier; and
over-riding, by a processing device during transmission of a data packet, the selected sub-carrier of the data packet with a wakeup signal to cause the wireless client to wake from a power saving mode.

2. The method of claim 1, wherein the wireless client is a first wireless client and the data packet is addressed to a second wireless client.

3. The method of claim 1, wherein the one or more wakeup signal parameters further comprise a wakeup bit pattern to be transmitted via the selected sub-carrier.

4. The method of claim 1, wherein the wakeup signal is a phase modulated signal.

5. The method of claim 1, wherein the one or more wakeup signal parameters further comprise a modulation scheme to be used for encoding the wakeup signal.

6. The method of claim 1, wherein the one or more wakeup signal parameters is received from the wireless client.

7. The method of claim 1, wherein over-riding the selected sub-carrier with the wakeup signal comprises inserting the wakeup signal at a selected input of an Inverse Fourier Transform (IFT) module, wherein the selected input is associated with the selected sub-carrier.

8. The method of claim 1, wherein over-riding the selected sub-carrier with the wakeup signal comprises replacing a plurality of bits of the data packet with a bit pattern that represents the wakeup signal.

9. The method of claim 1, wherein over-riding the selected sub-carrier with the wakeup signal comprises repeating a wakeup bit pattern over a full length of the data packet.

10. An apparatus comprising:
a transmitter configured to operate in accordance with an Orthogonal Frequency Division Multiplexed (OFDM) wireless communication protocol;
a memory configured to store configuration data; and
a processing device coupled to the memory, the processing device configured to:
receive data to be wirelessly transmitted to a wireless client;
identify, in the configuration data, one or more wakeup signal parameters associated with the wireless client, wherein the one or more wakeup signal parameters comprise a selected sub-carrier; and
during transmission of a data packet, control the wireless transmitter to over-ride the selected sub-carrier of the data packet with a wakeup signal to cause the wireless client to wake from a power saving mode.

11. The apparatus of claim 10, wherein the wireless client is a first wireless client and the data packet is addressed to a second wireless client.

12. The apparatus of claim 10, wherein the one or more wakeup signal parameters further comprise a wakeup bit pattern to be transmitted via the selected sub-carrier.

13. The apparatus of claim 10, wherein the wakeup signal is a phase modulated signal.

14. The apparatus of claim 10, comprising a switch array disposed between components of the transmitter and controllable by the processing device to insert the wakeup signal on a data line corresponding with the selected sub-carrier.

15. The apparatus of claim 14, wherein the transmitter comprises:
a modulator that generates a modulated signal representative of bits of the data packet; and
a Fourier Transform module that converts the modulated signal from a frequency domain representation to a time domain representation; and
wherein the switch array is disposed between the modulator and the Fourier Transform module.

16. The apparatus of claim 10, wherein the apparatus is a wireless Access Point (AP).

17. The apparatus of claim 10, wherein the apparatus is a personal computing device.

18. A method comprising:
entering a wireless module of a wireless client into a power saving mode;
monitoring, by a wakeup radio, radio frequency (RF) signals over a range of RF frequencies corresponding with a designated sub-carrier of an Orthogonal Frequency Division Multiplexed (OFDM) wireless communication protocol;
detecting, by a processing device of the wakeup radio, a wakeup signal specified for the wireless client to cause the wireless module to wake from the power saving mode; and
in response to detecting the wakeup signal, sending an activation signal to the wireless module to cause the wireless module to transition from the power saving mode to an active mode.

19. The method of claim 18, wherein monitoring comprises:
demodulating the RF signals according to a phase modulation scheme to generate a received bit pattern; and
comparing the received bit pattern to a wakeup bit pattern that represents the wakeup signal.

20. The method of claim 19, further comprising:
sending one or more wakeup signal parameters to a wireless host to enable the wireless host to wake the wireless module from the power saving mode, wherein the one or more wakeup signal parameters comprise the designated sub-carrier and the wakeup bit pattern.
